(19) United States
(12) Patent Application Publication
(10) Pub. No.: US 2015/0350102 A1
(43) Pub. Date: Dec. 3, 2015

(54) Method and System for Integrated Management of Converged Heterogeneous Resources in Software-Defined Infrastructure

(71) Applicants: Alberto Leon-Garcia, Toronto (CA); Hadi Bannazadeh, Thornhill (CA)

(72) Inventors: Alberto Leon-Garcia, Toronto (CA); Hadi Bannazadeh, Thornhill (CA)

(21) Appl. No.: 14/294,321

(22) Filed: Jun. 3, 2014

(51) Int. Cl. H04L 12/911; H04L 12/24

(52) U.S. Cl. CPC H04L 47/70; H04L 41/12

(57) ABSTRACT

A method and system for integrated management of converged heterogeneous resources is disclosed. The method includes: defining a Software-Defined Infrastructure (SDI) by separating data, control, and management for converged heterogeneous resource provisioning, creating an integrated resource manager using interfaces for one or more cloud controllers, Software-Defined Network (SDN) controllers, or general-resource controllers, enabling external entities to request and use the resources through interfaces, storing topology information and utilizing it for integrated resource management, and monitoring and measuring the converged heterogeneous resources. An integrated management system includes an SDI manager configured to provide integrated resource control and management functions, a cloud controller, an SDN controller, a general resource controller, a topology manager, northbound interfaces of an SDI manager for external entities to request resources and check the status of resources, and all inter-relations between an SDI manager, a cloud controller, an SDN manager, a general resource manager and a topology manager.

### BACKGROUND

1. Field

This invention relates generally to the field of computing and network resource management, and specifically to software-defined infrastructure. Still more particularly, the present disclosure relates to a method and system for integrated management of converged heterogeneous computing and networking resources for software-defined infrastructures, including cloud computing and/or software-defined networking

2. Description of the Related Art

Cloud computing is the use of dynamically-assigned computing resources (hardware and software) which are generally available in a remote location and accessible over the Internet. In cloud computing, a cloud controller is responsible for taking the high-level user descriptions, managing computing resources, placing virtual machines, allocating storage, and deciding where the image will run, and attaching networking to meet resource needs.

Cloud computing has stimulated the delivery of services and applications over the Internet and moved the computation and data from terminal devices and local servers to core massive datacenters due to advantages in flexibility, scalability, and economic savings. Cloud computing also allows customers to scale up and down their resource usage and to move virtual machines based on their needs. Virtualization is a key concept in providing flexible and scalable resource provisioning for computing, storage, and networking resources in the cloud-based systems. Various inventions [1-6] have been disclosed on how to efficiently allocate and manage resources according to dynamic needs and application requirements.

Software-defined networking (SDN) is an approach to building data networking equipment and software that separates and abstracts elements of these systems. SDN allows system administrators to provide network services more easily through abstraction of lower level functionality into virtual services. An SDN controller is an application in SDN that manages flows to enable more flexible, customized, and intelligent networking. SDN controllers are based on protocols, such as OpenFlow, that allow servers to configure switches how to process packets and where to forward them.

Software-Defined Networking (SDN) is an appealing platform for network virtualization. By separating the data plane and the control plane, SDN transforms network switches, in the data plane, into simple packet forwarding devices and allows a software program to control the behavior of the entire network. SDN enables flexible network control and monitoring through SDN controllers. OpenFlow is currently one of the most common southbound SDN interfaces. SDN and virtualization allows adaptation of routes and bandwidth to changing needs [8-11].

However, two separated resource management systems (one for computing and one for networking) are not sufficiently capable and flexible to address applications and multimedia services that require guaranteed service and quality levels. The end-to-end quality of a service or application is determined by the performance of underlying computing and networking resources and so these resources must generally be managed in coordinated fashion. Accordingly, previous approaches that separate resource management of cloud or network resources are not able to provide guarantees.

Integrated management of computing and networking resources would enable new management capabilities. For example, without integrated management of converged resources, previous approaches are not able to provide energy-aware forwarding and resource allocation because energy consumption information for the computing cloud and the network are not shared. In addition, resource allocation and migration can be improved based on the status of the converged heterogeneous resources.

In certain circumstances, using virtualization is not optimal—for example, when there are substantial requirements for performance (e.g., I/O and CPU) that are not compatible with the overhead of virtualization. In this case, direct management of the physical resource (“bare metal”) is preferable for satisfying the performance requirements. An integrated management system should therefore have the capability of supporting both virtual and bare metal resources.

While computing and networking resources provide the bulk of the support for cloud-based applications, other resources such as programmable hardware, GPUs and network processors provide critical support for certain services and applications. Current resource management systems are not capable of managing heterogeneous resources that include computing and networking resources in combination with other resources such as programmable hardware, GPUs and network processors. In addition current management systems do not apply virtualization methods to heterogeneous resources, and therefore are not capable of realizing the flexibility, scalability and economic advantages that would be inherent in the integrated management systems of converged heterogeneous resources.

Evidently, prior resource management methods and systems have not adequately addressed the requirements for services and applications based on converged heterogeneous resources. Thus, there remains a need to provide an integrated management method and system for the converged heterogeneous resources.

### SUMMARY OF INVENTION

### Terminology

A Physical resource typically includes processors, memory, peripheral devices or any resource such as computing servers, reconfigurable hardware (FPGA, NetFPGA), hardware-based accelerator (GPU), storage, network resource (router, switch, wireless access point), sensors, and so on.

A Virtual resource includes any resource virtualized on physical resources such as virtual machines, virtual computing resources, virtual storage, virtual network resources, virtual access points, and so on.

A Computing resource is any physical or virtual component of limited capacity within a computer system, such as computation and storage. Computing resources include conventional (computation, storage, volume) and non-conventional resources (reconfigurable hardware (FPGA, NetFPGA) and hardware-based accelerator (GPU), sensors, etc.).

A Networking resource is any physical or virtual component for communication. Networking resources include switches, routers, communication systems and wireless access points.

Software-Defined Infrastructure (SDI) is an approach for integrated control and management of converged and heterogeneous computing and networking resources that can be controlled, allocated and configured in software.

The present invention provides a method and system of providing integrated control and management of converged heterogeneous resources in an SDI where all resources are abstracted and defined/configured in software.

According to the first aspect of the present invention, an exemplary integrated management method for converged heterogeneous resources is provided. The exemplary integrated management method includes: defining an SDI by separating data, control, and management for converged heterogeneous resource provisioning, creating an integrated resource manager using interfaces for one or more cloud controllers, SDN controllers, or general-resource controllers, enabling external entities to request and use the resources through interfaces, storing topology information and utilizing it for integrated resource management, and monitoring and measuring the converged heterogeneous resources.

According to the second aspect of the present invention, an exemplary integrated management system for converged heterogeneous resources is provided. The exemplary integrated management system includes an SDI manager configured to provide integrated resource control and management functions, a cloud controller configured to take the high-level user descriptions and manage physical and virtual computing resources, an SDN controller configured to parse the network specification and translate the high level virtual network into configuration commands to physical and virtual network resources, a topology manager configured to store and manage all converged heterogeneous resources and their associations, northbound interfaces of an SDI manager for external entities to request resources and check the status of resources, and all inter-relations between an SDI manager, a cloud controller, an SDN manager, and a topology manager.

Other features and aspects may be apparent from the following detailed description, the drawings, and the claims.

### BRIEF DESCRIPTION OF THE DRAWINGS

The objects and features of the present invention will become apparent from the following description of embodiments, given in conjunction with the accompanying drawing, in which:

FIG. 1 depicts an exemplary configuration in which converged heterogeneous resources are managed by an SDI resource management system in accordance with the embodiment of the present invention;

FIG. 2 depicts an exemplary integrated management architecture in which an SDI manager can manage computing, networking, and other (“alpha”) resources using a cloud controller, an SDN controller, an alpha controller, and a topology manager;

FIG. 3 depicts an example system based on the SDI resource management architecture as shown in FIG. 2 in which an SDI manager can manage converged heterogeneous resources using OpenStack as a cloud controller and an OpenFlow controller as an SDN controller;

FIG. 4 depicts an example of the operation of an SDI resource management system for gathering converged heterogeneous resource information between an SDI manager, topology manager, a cloud controller, an SDN controller, and an alpha controller;

FIG. 5 depicts an example of the operation of an SDI resource management system for registering an event listener and processing events from each controller;

FIG. 6 depicts a flowchart of an exemplary process for an SDI resource provisioning method by an SDI resource management system using network topology information of converged heterogeneous resources;

FIG. 7 depicts a flowchart of an exemplary process for an SDI resource management method for supporting fault-tolerance in SDI;

FIG. 8 depicts a flowchart of an exemplary process for an SDI resource management method for supporting green computing and networking in SDI.

### DETAILED DESCRIPTION

Hereinafter, principles of the present invention will be described in detail with reference to the accompanying drawings, which form a part hereof. In the following description, well-known functions or configurations will not be set forth in detail if it may obscure the invention in unnecessary detail. Further, the following terms are defined in view of functions in the present invention, and may be changed depending on the user's intentions or the usage. Therefore, the terms should be construed by the whole contents of the description.

The present invention provides an integrated management method and system for converged heterogeneous resources which include conventional and non-conventional computing resources, storage resources, hardware resources, and network resources in SDI. Existing resource management systems support only conventional computing resources or network resources through cloud controller or SDN controllers, respectively. The present invention provides a flexible, programmable and integrated resource management method and system by not only using both controllers but also extending to support non-conventional computing and other resources.

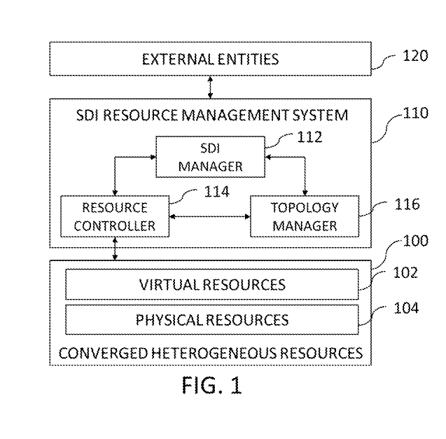

FIG. 1 depicts a configuration in which converged heterogeneous resources 100 are managed by an SDI resource management system 110, in which an SDI manager 112 can control and manage the resources using a resource controller 114 and a topology manager 116. External entities 120 obtain virtual resources in the converged heterogeneous resources 100 via the SDI resource management system 110.

The converged heterogeneous resources 100 are composed of virtual resources 102 and physical resources 104. Virtual resources 102 include any resource virtualized on the physical resources such as virtual machines, virtual computing resources, virtual storage, virtual network resources, virtual access points, and so on. Physical resources 104 include any resource that can be abstracted or virtualized, such as computing servers, reconfigurable hardware (FPGA, NetFPGA), hardware-based accelerators, Graphics Processing Unit (GPU), network processors, storage, network resources (router, switch, wireless access point), communication systems and links, sensors, and so on. The SDI resource management system 110 provides general resource management functions for the converged heterogeneous resources to the external entities 120. The resource management functions include provisioning, registry/configuration management, virtualization, allocation/scheduling, migration/scaling, monitoring/measurement, load balancing, energy management, fault management, performance management (delay, loss etc), and security management (authentication, policy, role). The external entities 120 can be applications, users (service developers or providers), and high-level management systems (Network Management System (NMS), Operations Support System (OSS), or Business Support System (BSS)).

The SDI manager 112 can perform coordinated and integrated resource management for converged heterogeneous resources 100 through the resource controller and the topology manager 116. The SDI manager 112 can perform major integrated resource management functions: fault tolerance, green networking (energy efficient and/or low-carbon emitting), path optimization, resource scheduling optimization, network-aware VM replacement, QoS support, real-time network monitoring, and flexible diagnostics based on network topology information from a topology manager 116. Some examples for the resource management functions will be presented later. The resource controller 114 is responsible for managing physical 104 resources and virtual resources 102. The topology manager 116 maintains a list of the resources, their relationships, and monitoring and measurement data for the resources. The topology manager 116 provides up-to-date resource information to the SDI manager 112 for topology-aware resource management.

The external entities 120 use the SDI resource management system 110 for a variety of purposes, including resource requests (authentication/authorization), resource status monitoring/measurement, and resource availability. The SDI resource management system 110 manages converged heterogeneous resources 100 for virtual resource setup/control, physical resource control, and resource monitoring/measurement.

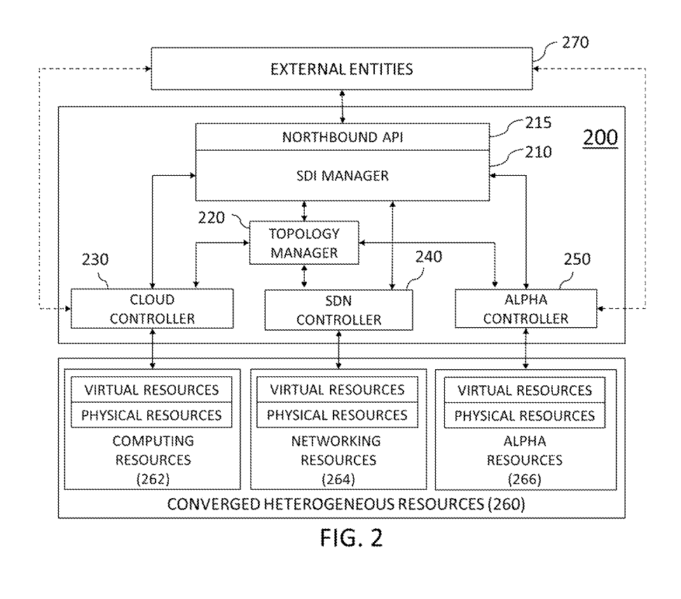

FIG. 2 depicts a high-level architecture for the SDI resource management system 110, 200 in which an SDI manager 210 can control and manage converged heterogeneous resources 260 including computing 262, networking resources 264, and other (“alpha”) resources 266 using the cloud controller 230, the SDN controller 240, and one or more alpha controllers 250, respectively.

The resource controller 114 can be divided into the specific controllers which are responsible for managing the different resources. In this example configuration, the cloud controller 230, the SDN controller 240, and the alpha controller 250 are presented. The cloud controller 230 is responsible for taking the high-level user descriptions and managing computing resources 262, placing virtual machines, and allocating storage. The SDN controller 240 is responsible for taking network specification and translates the high level configuration commands that can be installed on SDN-enabled networking resources 264. The alpha controller 250 is responsible for taking resource specification and configuring alpha resources. The topology manager 220 obtains a list of the computing, networking, and alpha resources, their relationships, and monitoring and measurement data for the resources. The computing resources 262 include conventional resources such as computation, storage, and volume. The networking resources 264 include switches, routers, and wireless access points as a physical networking resource, and virtual switches, virtual routers, and virtual access points as a virtual networking resource. The alpha resources include non-conventional resources such as reconfigurable hardware (FPGA, NetFPGA) and hardware-based accelerators, GPUs, sensors and so on. External entities 270 can be applications, users, and high-level management systems such as NMS, OSS, or BSS. These high-level management systems can directly control and manage controllers if the SDI manager 210 allows them to access the controllers.

The SDI manager 210 uses the cloud controller 230 for computing resource provisioning, migration, load balancing, and scaling and the cloud controller 230 provides the requested virtual computing resources to the SDI manager 210. The SDI manager 210 uses the SDN controller 240 for controlling and managing networking resources, and the SDN controller 240 provides virtual network resources and monitoring data to the SDI manager 210. The SDI manager 210 uses the alpha controller 250 for controlling and managing alpha resources which are different kinds of resources unlike the cloud and networking resources, and the alpha controller 250 provides alpha resources to the SDI manager 210. The SDI manager 210 uses the topology manager 220 for setting resource cost properties and metrics, and updating resource data, and the topology manager 220 provides physical and virtual network topology and associated status information, and resource monitoring and measurement data to the SDI manager 210. The cloud controller 230 provides physical and virtual computing resource data and monitoring and measurement data to the topology manager 220. The SDN controller 240 provides physical and virtual network topology data, resource status data, and monitoring and measurement data to the topology manager 240. The alpha controller 250 provides physical and virtual alpha resource data, and monitoring and measurement data to the topology manager 220. The cloud controller 230 virtualizes and controls virtual resources based on the computing resources 262, the SDN controller 240 controls networking resources 264, and the alpha controller 250 controls alpha resources 266.

The present invention can use single or multiple, possibly different kinds of cloud controllers. The cloud controller 230 can be instantiated as a single or multiple instances of possibly different cloud controllers. Likewise, the present invention can use single or multiple instances of possibly different kinds of SDN controllers. The SDN controller 240 can be instantiated as a single or multiple instances of possibly different SDN controllers. The present invention can use single or multiple possibly different kinds of alpha controllers. Of particular interest is the case where one or more of the controllers provide open interfaces. One of the example systems will be presented below.

External entities 270 use northbound API 215 provided by SDI manager for controlling and managing converged heterogeneous resources. External entities 270 can directly access the cloud controller 230, the SDN controller 240, and the alpha controller 250 by using open APIs if the endpoint for each controller is known to the external entities 270.

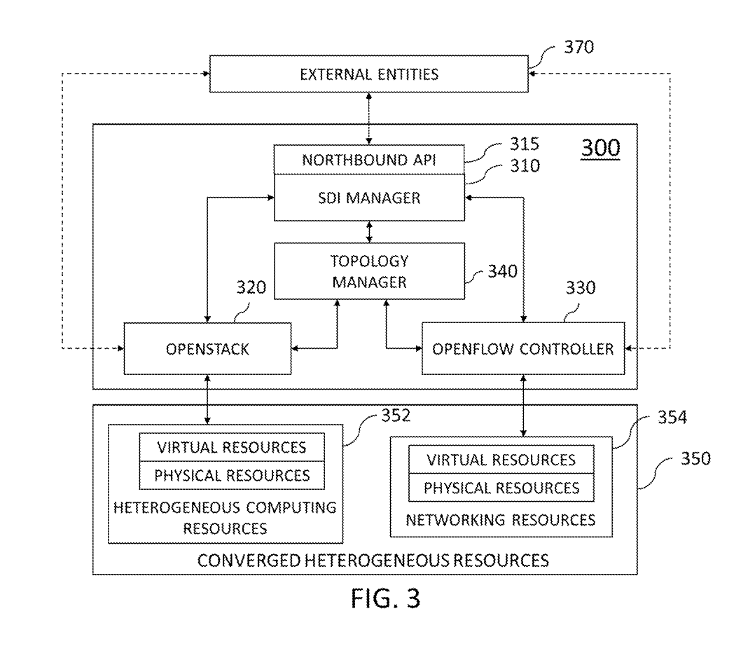

FIG. 3 depicts an example system 300 based on the SDI resource management architecture as shown in FIG. 2 in which an SDI manager 310 can manage converged heterogeneous resources 350 using OpenStack 320 as a cloud controller 230 and an OpenFlow controller 330 as an SDN controller 240 according to an embodiment of the present invention.

The present invention can support conventional and non-conventional computing resources via the same management system. The cloud controller 230 provides any virtual resource based on the given ‘flavor’ which is an available hardware configuration for a server. Each flavor has a unique combination of disk space, memory capacity, and the number of virtual CPUs. In the SDI manager of the present invention, we introduce a new flavor for each new resource. This allows our SDI manager to support heterogeneous resources by use of different flavors within a common management method. In the example in FIG. 3, OpenStack 320 as a cloud controller and as an alpha controller provides control of conventional and non-conventional resources by defining flavors for all resources.

The system 300 can manage many computing 352 and networking resources 354 for provisioning to external entities 370. The SDI resource management system 300 controls and manages virtual computing resources by virtualizing physical computing resources using OpenStack 320, which is an open source cloud controller that controls large pools of computation, storage, and networking resources. The topology manager 340 stores information about all converged heterogeneous resources and their associations by interacting with the OpenStack 320, the SDI manager 310, and the Openflow controller 330. In the example of the embodiment, the Openflow controller can be used for controlling networking resources. The Openflow controller 330 receives all events from the Openflow switches and makes a flow table including actions. The SDI manager 310 performs all management functions based on the data from the OpenStack 320 and the Openflow controller 330, and determines appropriate actions for computing and networking resources.

The Openflow controller 330 may include a proxy that mediates access from multiple Openflow controllers to the networking resources 354. Said proxy can be designed to coordinate and prevent conflicts among the rules installed by multiple Openflow controllers on the networking resources. In one embodiment of the Openflow controller, a Flowvisor acts as a transparent proxy between the Openflow switches and multiple Openflow controllers 330. The Flowvisor creates slices of network resources and delegates control of each slice to a different controller. The Flowisor enforces isolation between slices. The introduction of a proxy controller enables any user to use its own Openflow controller via the Flowvisor, even though it is outside the system 300.

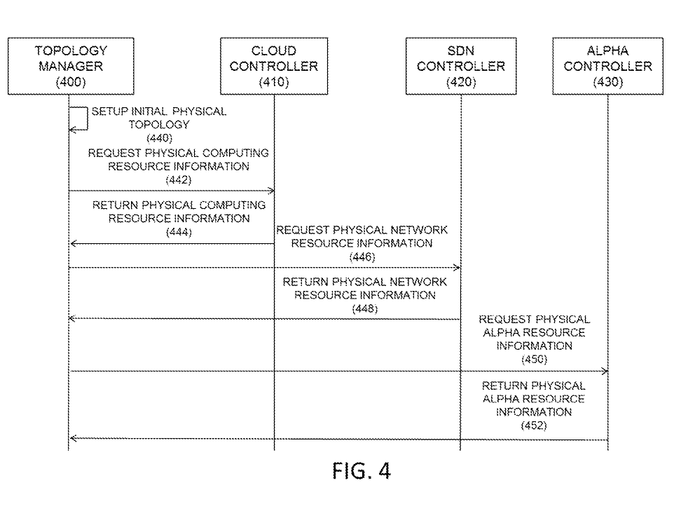

FIG. 4 depicts an example of the initial operation of an SDI resource management system for setting up converged heterogeneous resource information between a topology manager 400, a cloud controller 410, an SDN controller 420, and an alpha controller 430.

As shown therein, the topology manager 220, 400 sets up an initial physical topology in step 440 manually or automatically, for example, through a discovery process. The initial physical topology includes known resource information such as a server list, a network interface list, and an available link list. Next, the topology manager 400 requests in step 442 the physical computing resource information from the cloud controller 410; the cloud controller 410 retrieves available computing resource information and returns it to the topology manager 400 in step 444. The topology manager 400 requests in step 446 physical network resource information from the SDN controller 420; the SDN controller gathers current physical network resource information and returns it to the topology manager 400 in step 448. The topology manager 400 requests in step 450 physical alpha resource information to the alpha controller 430; the alpha controller gathers current physical alpha resource information and returns it to the topology manager 400 in step 452.

After loading the pre-defined topology information, the topology manager updates all physical resource information and virtual resource information periodically according to information received from the cloud controller, SDN controller, and alpha controller.

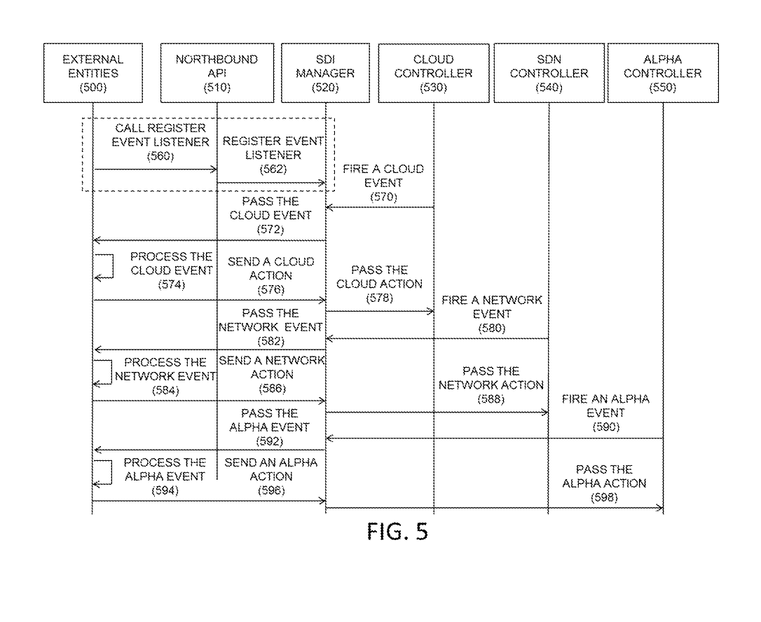

FIG. 5 depicts an example of the operation of an SDI resource management system for registering an event listener and processing events from each controller.

As mentioned for FIG. 2, the SDI manager 210 receives event information from each controller and processes these as necessary. However, the present invention allows external entities 270 to register event listeners with the SDI manager 210 and to process the events from each controller directly via northbound API 215. As shown therein, if the external entities 500 want to process events from the controller directly, the external entities 500 call the northbound API 510 to register an event listener with the SDI manager 520 in step 560 and step 562.

When a cloud event is fired from the cloud controller 530, the SDI manager 520 first receives the event in step 570. If an event listener for the cloud event exists, the SDI manager 520 passes the cloud event to the external entities that own the event listener in step 572. Then, the external entities 500 process the cloud event in step 574 and determine the proper action. Next, the external entities 500 send the cloud action to the SDI manager in step 576. The SDI manager 520 passes the cloud action to the cloud controller 530 in step 578.

Similarly, when a network event is fired from the SDN controller 540, the SDI manager 520 first receives the event in step 580. If an event listener for the network event exists, the SDI manager 520 passes the network event to the external entities 500 that own the event listener in step 582. Then, the external entities 500 process the network event in step 584 and determine the proper action. Next, the external entities 500 send the network action to the SDI manager in step 586. The SDI manager 520 passes the network action to the SDN controller 540 in step 588.

Finally, when an alpha event is fired from the alpha controller 550, the SDI manager 520 first receives the event in step 590. If the event listener for the alpha event exists, the SDI manager 520 passes the alpha event to the external entities 500 that own the event listener in step 592. Then, the external entities 500 process the alpha event in step 584 and determine the proper action. Then, the external entities 500 send the alpha action to the SDI manager in step 596. The SDI manager 520 passes the alpha action to the cloud controller 530 in step 598.

In order to provide more detailed examples of the operation of the present invention, three examples are presented: 1) network topology-aware VM allocation, 2) fault-tolerance management, and 3) green networking. The SDI management system of the present invention is highly versatile and can implement a wide range additional resource management and control functions.

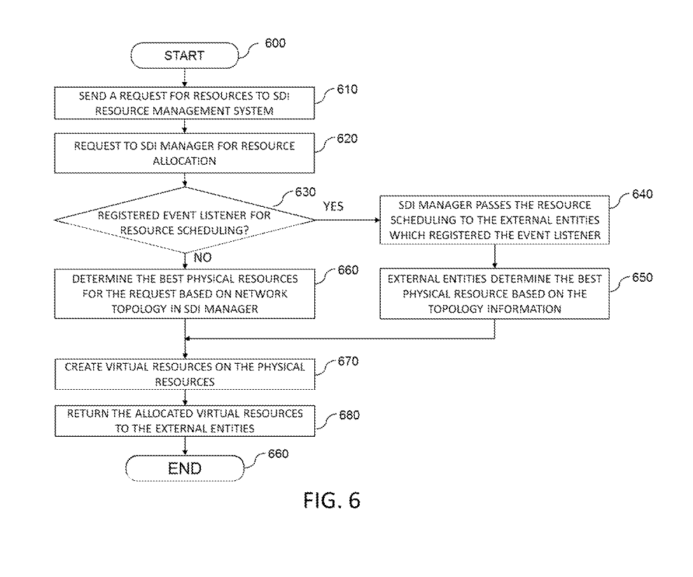

FIG. 6 depicts a flowchart of an exemplary process for a resource provisioning method by the SDI resource management system 200 using network topology of converged heterogeneous resources.

Traditionally, virtual resources (e.g. virtual machine) are allocated based on the capacity of physical resource. The present invention can allocate virtual resources based not only on the capacity of individual physical resources but also on network topology information (e.g., bandwidth). This can enable more optimized resource allocation in SDI. In 600, processing for resource allocation begins. In 610, an external entity 270 sends a request for resources to the SDI resource management system 200. For example, external entity 270 can request three virtual machines and one virtual network with preferred requirements. In 620, the request is transferred to the SDI manager 210 for proper resource allocation. In 630, the SDI manager 210 determines if there is any registered event listener for the resource scheduling. If so, the SDI manager 210 can pass the resource scheduling to the external entities 270 which registered the event listener in 640. In 650, the external entities 270 determine the best physical resource based on the topology information and send the result to the SDI manager 210. Otherwise, the SDI manager 210 determines the best physical resources for the request based on network topology information available from the topology manager 220 and the given requirements. In 670, the SDI manager 210 requests the cloud controller 230 to create virtual resource(s) on the selected physical resources and the SDN controller 240 to control the virtual network resource(s). In 680, the SDI manager 210 returns the allocated virtual resource(s) to the external entities 270.

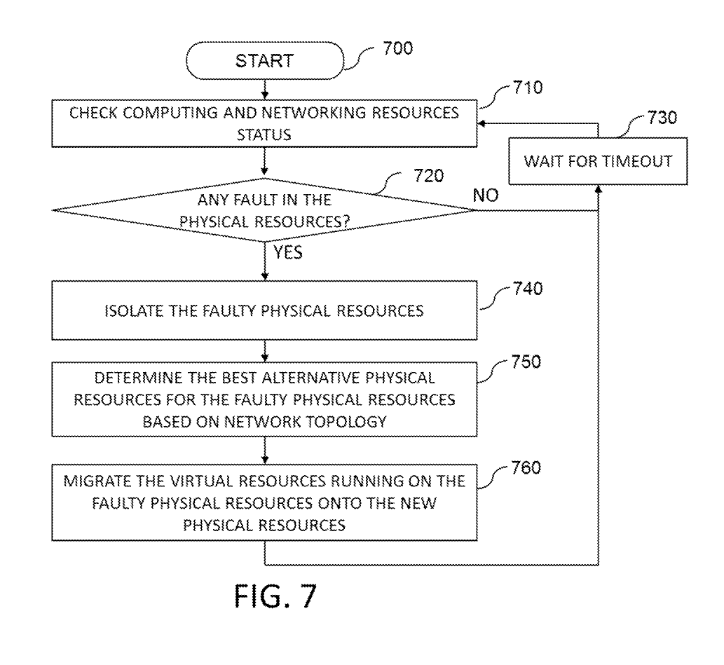

FIG. 7 depicts a flowchart of an exemplary process for an SDI resource management method for supporting fault-tolerance in SDI. This flowchart shows an example in which the SDI resource management system 200 can maintains sufficient virtual resource availability even though there are faults in physical resources.

The SDI manager periodically checks the state of its resources. If there is any fault in physical or virtual resources (e.g., physical host fault, link fault), the SDI manager can detect it and initiate recovery. In SDI, control and data interfaces for all physical resources are available for control and management. We can remove all VM hosts running on the faulty physical resources or physical resources connected to faulty network links. Then, we reallocate or migrate the virtual resources to other physical resources, which are determined by network topology information.

In 700, processing begins. In 710, the SDI manager 210 periodically checks the status of virtual resources as one of its virtual resource management functions. In 720, the SDI manager 210 can determine if there is any fault in the physical resources using a control link. If so, the SDI manager 210 isolates the faulty physical resources in 740. Otherwise, the SDI manager 210 can wait for a moment specified in the timeout in 730 and continue to check the virtual resource status in 710.

In 750, the SDI manager 210 can determine the best alternative physical resources for the faulty physical resources based on the current network topology information as it does in 660. In 760, the SDI manager 210 can start migration of the virtual resources running on the faulty physical resources onto the selected physical resources by requesting to the cloud controller 230. Then, the SDI manager 210 can wait for a moment and continue to check the virtual resource status in 710.

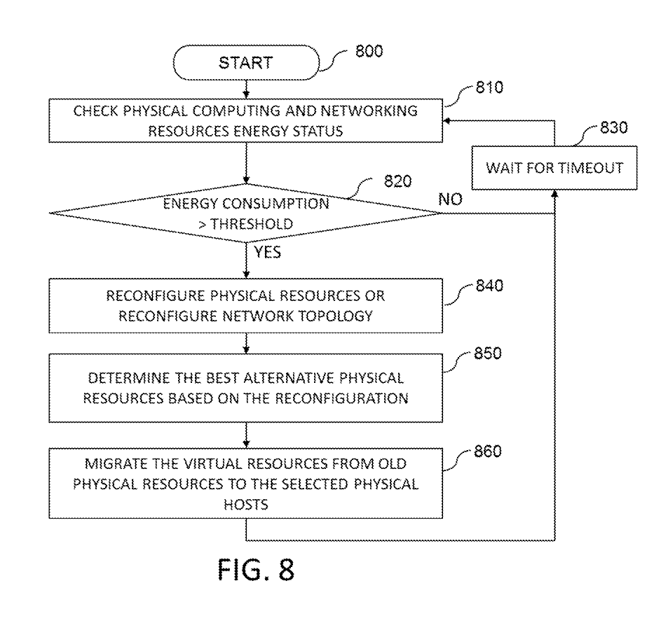

FIG. 8 depicts a flowchart of an exemplary process for an SDI resource management method for supporting green computing and networking in SDI. This flowchart shows an example in which the SDI resource management system 200 can operates to minimize energy consumption of the physical computing and networking resources.

In SDI, the minimizing of energy consumption is a major concern. The SDI manager can save energy of all converged heterogeneous resources by turning activating or turning off physical resources (computer hosts, switches, routers, access points etc), by selecting routes and allocating jobs, reconfiguring the topology of resources, or reconfiguring active and sleeping resources.

In 800, processing begins. In 810, the SDI manager 210 checks the status of physical computing and networking resources as one of its physical resource management functions. In 820, the SDI manager 210 can determine if the energy consumption for whole physical network is greater than the pre-defined threshold. If so, the SDI manager 210 can start to reduce energy consumption by reconfiguring physical resources, such as hosts and routers, (e.g., turning on/off physical hosts that have no running virtual resources), selecting new routes (e.g., selecting shortest and energy-aware routing path), reconfiguring network topology, or reconfiguring active and sleeping access points and their coverage in 840. Otherwise, the SDI manager 210 can wait for a moment specified in the timeout in 830 and continue to check the physical resource status in 810. In 850, the SDI manager 210 can determine the best alternative physical resources based on the reconfigured physical resource or network topology. In 860, the SDI manager 210 can start migration of the virtual resources running on the old physical resources onto the selected physical resources by requesting to the cloud controller 220. Then, the SDI manager 210 can wait for a moment and continue to check the virtual resource status in 810. The SDI manager can implement “green” resource management by using the level of carbon emissions associated with the operation of physical resources associated with active virtual resources, instead of solely energy consumption, in the general operation depicted in FIG. 8.

### REFERENCE

[1] Yan et al. “Method and System for Managing Heterogeneous Resources Across a Distributed Computer Networks,” US 2005/0273507 A1, Dec. 8, 2005
[2] Maddhuri et al. “Allocating Computer Resources in a Cloud Environment,” U.S. Pat. No. 8,352,611 B2, Jan. 8, 2013
[3] Lee et al. “Resource Management Apparatus and Method for Supporting Cloud-based Communication between Ubiquitous Objects,” US 2012/0144041 A1, Jun. 7, 2012
[4] Diwakar et al., “System and Method for Selecting Services from Multiple Cloud Vendors,” US 2011/0238515 A1, Sep. 29, 2011
[5] Jain et al. “Resource Management for Cloud Computing Platforms,” US 2012/0330711 A1, Dec. 27, 2012
[6] Balani, “Configuring Cloud Resources,” U.S. Pat. No. 8,341,269 B2, Dec. 25, 2012
[7] Carter et al. “Techniques for Evaluating and Managing Cloud Networks,” US 2011/0289440 A1, Nov. 24, 2011
[8] Spicer et al. “Network Resource Control System,” U.S. Pat. No. 7,007,093 B2, Feb. 28, 2006
[9] Xiong et al. “Method and System of Centralized Control and Management for Fiber Channel Over Ethernet Networks,” US 20120275467, Nov. 1, 2012
[10] Koponen et al. “Network Control Apparatus and Method for Populating Logical Datapath Sets,” US 20120120964 A1, May 17, 2012
[11] Chawla et al. “System and Method for Scalable Flow Aware Network Architecture for Openflow Based Network Virtualization,” US 20120099591 A1, Apr. 26, 2012

The embodiments of the invention in which an exclusive property or privilege is claimed are defined as follows:

1. An integrated SDI management system for providing converged heterogeneous resources to external entities, said system comprising an SDI manager to control and manage the resources using a resource controller and a topology manager, where:
a. said converged heterogeneous resources are composed of virtual resources and physical resources;
b. said SDI management system provides general resource management functions for the converged heterogeneous resources to the external entities;
c. said external entities can be applications, users, and high-level management systems;
d. said external entities use the SDI resource management system for a variety of purposes, including resource requests, resource status monitoring/measurement, and resource availability;
e. said SDI manager performs coordinated and integrated resource management for converged heterogeneous resources through the resource controller and the topology manager;
f. said topology manager maintains a list of the resources, their relationships, and monitoring and measurement data for the resources;
g. said resource controller manages physical resources and virtual resources.

2. The integrated SDI management system of claim 1 for providing converged heterogeneous resources to external entities, said system comprising an SDI manager to control and manage the resources using a resource controller and a topology manager, where:
a. said resource controller is comprised of two or more controllers which are responsible for managing heterogeneous resources;
b. said controllers may include one or more cloud controllers, one or more SDN controllers, and one or more alpha controllers;
c. said cloud controllers are responsible for taking the high-level user descriptions and managing computing resources, placing virtual machines, and allocating storage;
d. said SDN controllers are responsible for taking network specification and translating the high level configuration commands that can be installed on SDN-enabled networking resources;
e. said alpha controllers are responsible for taking resource specification and configuring alpha resources;
f. said topology manager maintains a list of the computing, networking, and alpha resources, their relationships, and monitoring and measurement data for the resources;
g. said topology manager provides resource status information to the SDI manager;
h. said external entities can directly control and manage controllers if the SDI manager allows them to access the controllers;
i. said SDI manager may use the topology manager for setting resource cost properties and metrics, and updating resource data.

3. The integrated SDI management system of claim 2 where:
a. one or more cloud controllers use OpenStack;
b. one or more SDN controllers use OpenFlow;
c. flavors may be introduced to enable OpenStack to manage alpha resources.

4. The integrated SDI management system of claim 3 where the SDN controller includes a proxy that mediates access from multiple OpenFlow controllers to the networking resources, where said proxy coordinates and prevents conflicts among the rules installed by multiple OpenFlow controllers on the networking resources.

5. The integrated SDI management system of claim 2 where one or more alpha controllers control the resources of software-defined radio systems.

6. The integrated SDI management system of claim 2 where one or more alpha controllers control the resources of one or more legacy networks.

7. The integrated SDI management system of claim 6 where one or more of the legacy networks are MPLS networks.

8. The integrated SDI management system of claim 6 where one or more of the legacy networks are wireless networks.

9. The integrated SDI management system of claim 6 where one or more of the legacy networks are WIFI networks.

10. The integrated SDI management system of claim 6 where one or more of the legacy networks are LTE networks.

11. The integrated SDI management system of claim 6 where one or more of the legacy networks are optical networks.

12. The integrated SDI management system of claim 6 where one or more of the legacy networks are Internet Protocol networks.

13. The integrated SDI management system of claim 2 where one or more alpha controllers use the Simple Network Management Protocol (SNMP) to manage network resources.

14. The integrated SDI management system of claim 2 where one or more alpha controllers use the Network Configuration Protocol (NETCONF) to manage resources.

15. The integrated SDI management system of claim 2 where one or more alpha controllers control FPGA resources.

16. The integrated SDI management system of claim 3 where a flavor is introduced to enable OpenStack controllers to manage FPGA resources.

17. The integrated SDI management system of claim 2 where one or more alpha controllers control sensor resources.

18. The integrated SDI management system of claim 2 where one or more alpha controllers control sensor network resources.

19. The integrated SDI management system of claim 2 allowing external entities to register event listeners in the SDI manager to process the events from each controller directly or via a Northbound API.

20. The integrated SDI management system of claim 2 operating so that aggregate resource consumption metrics, such as total energy consumption or total carbon emissions, are minimized.
